(19) United States
(12) Patent Application Publication
(10) Pub. No.: US 2016/0267543 A1
(43) Pub. Date: Sep. 15, 2016

(54) TARGETING AND CHANNELING DIGITAL ADVERTISEMENTS TO SOCIAL MEDIA USERS THROUGH LOCATION-BASED SOCIAL MONITORING

(71) Applicant: WeLink, Inc., San Jose, CA (US)

(72) Inventor: Karthik Mavaneethan Manimaran, San Jose, CA (US)

(21) Appl. No.: 14/656,550

(22) Filed: Mar. 12, 2015

(51) Int. Cl. G06Q 30/02; G06Q 50/00

(52) U.S. Cl. CPC G06Q 30/0269; G06Q 50/01; G06Q 30/0261

(57) ABSTRACT

Embodiments of an information management system and related methods are disclosed. In some embodiments, the system receives from an advertising platform advertising criteria characterizing intended customers or their activities, such as their locations. To identify the intended customers, the system collects social media contents and metadata from social media networks or social media data collectors. The system can enrich the social media data with geotags and other information, and it can adjust the advertising criteria for better characterization of the intended customers or easier matching with the social media data. The system examines the enriched social media data with respect to the adjusted advertising criteria to identify social media users who satisfy those advertising criteria. Next, the system makes available the IDs or additional data of the identified social media users to the advertising platform, which can then advertise to these social media users though the social media.

### RELATED APPLICATION

The present application is related to U.S. patent application Ser. No. 14/656,252, filed Mar. 12, 2015 and titled “COLLECTING AND GENERATING GEO-TAGGED SOCIAL MEDIA DATA THROUGH A NETWORK ROUTER INTERFACE”, which is incorporated by reference in its entirety.

### TECHNICAL FIELD

The present application is related to advertising in social media and, in particular, to targeted advertising based on user locations and other criteria.

### BACKGROUND

Advertising is shifting from traditional platforms and media—such as television, telemarketing/phone, and paper—to digital media. Among the notable digital media are email, blogs, websites, advertisement banners and social media networks. In recent years, social media advertising has gained significant momentum. Through this digital platform, a business can quickly spread an announcement regarding activities taking place at a certain location and attract customers who are mostly at or near that location. However, this passive approach is limited in its reach. It would be more effective for the business to advertise to a broad group of current and prospective customers and proactively organize advertising activities based on customer needs or preferences.

### BRIEF DESCRIPTION OF THE DRAWINGS

Various embodiments are disclosed in the following detailed description and accompanying drawings.

FIG. 1 is an environment diagram illustrating an example environment in which an information management system disclosed in the present application can operate.

FIG. 2 illustrates example components of the information management system.

FIG. 3 illustrates example social media data.

FIG. 4 illustrates an example process performed by the information management system to assist an advertising platform of an advertiser with targeting users of social media.

FIG. 5 illustrates an example process performed by an advertising platform to target users of social media with the assistance of the information management system.

FIG. 6 is a high-level block diagram showing an example architecture of a computer, which may represent any electronic device, any server, or any node within a cloud service as described herein.

### DETAILED DESCRIPTION

Today, geo-feeds within social media allow advertisers to be more proactive in their advertising strategies. Advertisers can determine their advertising strategies based on where present and prospective customers are and have been. Social media data contains geo-feeds and a wealth of other information that the advertisers may utilize to create more effective advertisement campaigns. This application discloses an information management system and related methods that assist advertising platforms of advertisers with targeting users of social media by analyzing social media data.

In some embodiments, the information management system receives from an advertising platform of an advertiser one or more advertising criteria, one of them being related to a physical location. The system also receives from a social media content provider a plurality of social media contents created by a plurality of users and associated metadata. The system then analyzes the received social media contents and metadata with respect to the received advertising criteria and identifies, from the plurality of users, a subset of users who satisfy the advertising criteria based on the analysis. Finally, the system releases IDs of the subset of users to the advertising platform to enable targeted advertising.

In some embodiments, the information management system enables an advertising platform of an advertiser to perform targeted advertising. Initially, the advertising platform sends to the information management system one or more advertising criteria, one of the advertising criteria being related to a physical location. The information management system then analyzes contents and metadata of one or more social media with respect to the advertising criteria to identify social media users who satisfy the advertising criteria. As a result, the advertising platform receives from the information management system IDs of the identified social media users.

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and the equivalent.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

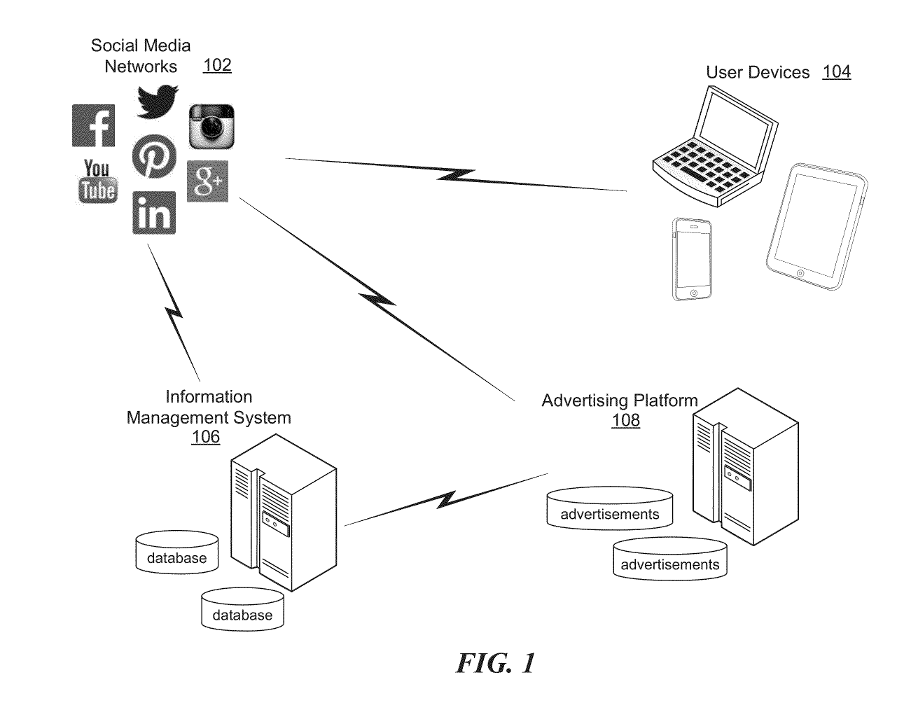

FIG. 1 is an environment diagram illustrating an example environment in which the information management system can operate. In some embodiments, the information management system 106 comprises servers and databases that possess sufficient data storage and processing power as well as networking and communication capabilities. In general, users of social media, maintained by companies such as Twitter, Instagram, Facebook, Google Plus, Youtube, Flickr, Picasa, Foursquare, Nextdoor, Pinterest, Yelp, 500px, Photobucket, Panaromio, Meetup, Eventbrite, Dailymotion, Viddy, Soundcloud, YikYak, Snapchat, Whisper, Secret, TripAdvisor, Expedia, Travelocity, etc., produce social media contents through user devices 104, such as mobile phones, tablets, laptop computers, desktop computers, and wearable devices. The user devices 104 transmit the social media contents to the social media networks 102 across computer networks. The system 106 receives social media contents and metadata from the social media networks 102, social media plugins, or social media data collectors which aggregate social media data streams, such as Firehose, through computer networks, such as the Internet. Social media metadata can include information identifying a social media user, the user's device, the user's location, and so on.

In some embodiments, the system 106 also receives advertising criteria from an advertising platform 108 of an advertiser conducting an advertising campaign. The advertising criteria specify characteristics of intended customers, which may include locations, demographic information, interests, and many others. In order to identify the intended customers, the system 106 processes and digests the collected social media contents and metadata, analyzing attributes and activities of the social media users and selecting from these social media users who might satisfy the advertising criteria. Subsequently, the system 106 informs the advertising platform 108 of the list of social media users so that the advertising platform 108 can send appropriate advertisements to those social media users through the social media.

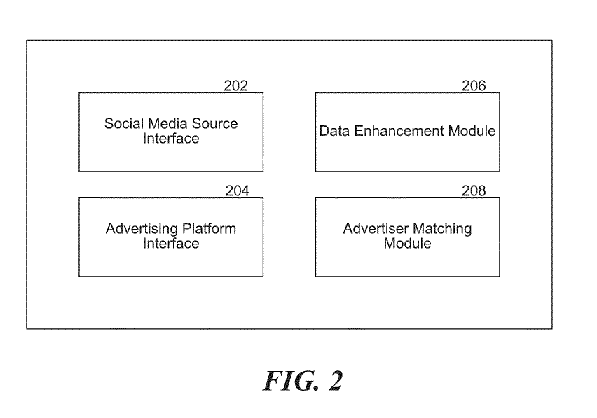

FIG. 2 illustrates example components of the information management system. In some embodiments, the system includes a social media source interface 202, a data enhancement module 206, an advertiser matching module 208, and an advertising platform interface 204.

In some embodiments, the social media source interface 202 manages interactions with social media sources, including social media networks, social media plugins, and social media data collectors. The social media source interface 202 obtains social media contents and metadata from these social media sources through a published application programming interface (API) or any other specified access mechanism. For example, Facebook makes data available through an API, while Firehose delivers data in a supported format, such as JSON. The social media data can also obtained from crawling social media websites. The retrieval of the social media data can take place on a daily basis, upon a specific request from an advertising platform, or according to any other schedule.

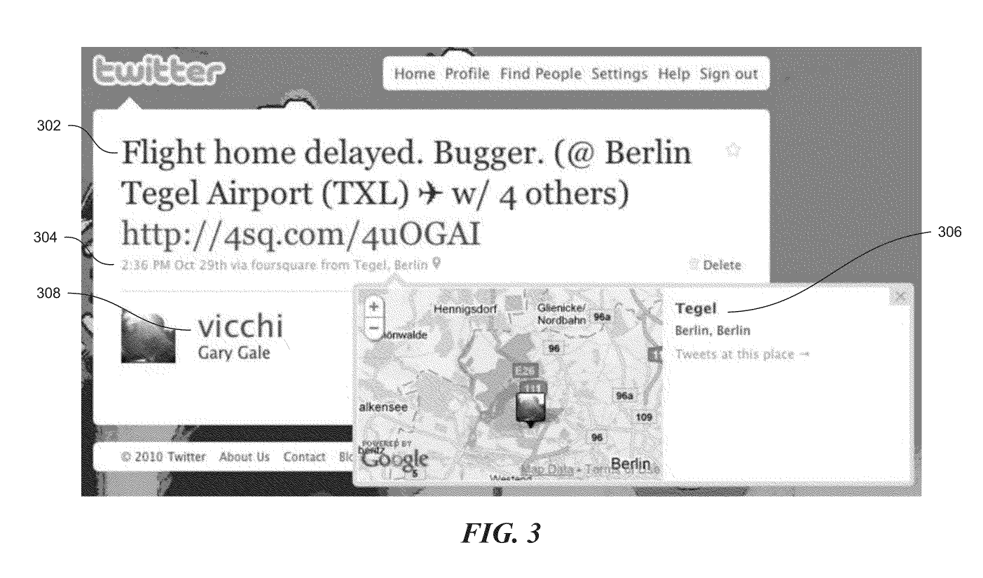

FIG. 3 illustrates example social media data. The data corresponds to a tweet. The tweet includes a message 302, which is normally considered as the content of the tweet and includes text but could include other types of data, such as images and videos. The content may be dissected to deduce various types of information regarding the social media user or the author of the message. For example, the word “flight” may indicate that the user is travelling, the word “bugger” may indicate frustration, the words “Tegel Airport” and “(TXL)” may indicate the user's current or recent location, and the uniform resource location (URL) http://4sq.com/4uOGAI and the referenced content may indicate additional interests of the user. The tweet also includes author information 308 indicating who composed and sent the message, time information 304 indicating when the message was sent, and location information 306 indicating where the message was sent from. Such information can be considered part of the content but is more often considered part of the metadata of the tweet. Not all types of metadata may exist for a tweet. For example, when a user does not turn on the geotag feature, the location information would not be stored with the content. On the other hand, metadata besides user, location, and time information may be stored with the tweet depending on the collector of the social media data. For example, together with the message, Firehose may make available language information indicating in which language the message was written and klout information indicating the user's influence ranking. The content and the metadata can both be analyzed to determine attributes and activities of the author.

In some embodiments, the data enhancement module 206 enriches the social media contents and metadata received from the sources. One factor that is important for effective advertising is user location. However, not every piece of social media data includes location information. For example, location services are turned off by default with Twitter, so a user needs to turn on the location services to attach a location to a tweet. Therefore, one way the data enhancement module 206 can enrich the received social media data is to uncover as much location information as possible.

As discussed in the related application U.S. patent application Ser. No. 14/656,252, the information management system can collect information from network routers and use the information to enrich social media data received from various social media sources. In some embodiments, the data enhancement module 206 first relies on a data aggregator to collect router data from network routers regarding a network router, devices connected to the network router, or users using the connected devices. Specifically, the router data can include the location of the network router and for a connected device, the MAC address and locations of visited websites together with the times of visits. The data enhancement module 206 then joins the network router data to the social media data mainly based on timestamps.

In some embodiments, the data enhancement module 206 enhances the social media data in various ways based on the joined data. In one approach, when a first and a second devices are connected to the same network router, even if the social media data posted by the first device does not include location information, if the network router is associated with location information or if the social media data posted by the second device includes location information, the data enhancement module 206 can assign the same location information to the social media data posted by the first device since both devices are connected to the same network router and thus are typically in the proximity of the router. In addition, based on the MAC address of the first device, even if the first device later is connected to a different network router or communicates with a different social media network, the data enhancement module 206 can associate the published social media data with the same first device and its user to obtain more information about the user. The information generated by a network router can include additional detail, such as device types, timestamps of online activities performed outside the social media, etc., which can also be used to enrich the received social media data and make additional inferences regarding the social media users.

In some embodiments, the advertiser matching module 208 identifies social media users that may satisfy the advertising criteria received from an advertising platform of an advertiser. The advertising criteria would be aligned with the goal of any particular advertising campaign of the advertiser and would characterize the intended audience of the advertising campaign. Example advertising criteria include a user's demographic information (gender, age, race, marital status, etc.), interests and hobbies, income level, shopping preferences, location, permanent address, and online influence. Example advertising criteria would often be based on the advertiser's business information, such as office locations, operating hours, size, and industry focus.

In some embodiments, the advertiser matching module 208 can modify the received advertising criteria. For example, an advertising criterion can be as broad as students, which can be specified as people between the ages of 6 and 22. It can be as narrow as a stadium or a retail store, which can be broadened into the city where the stadium or the retail store is located. It can also be as descriptive as an interest in fashion, which can be translated into a user's discussion or purchase history of clothes or accessories. In addition, the advertiser matching module 208 can predetermine advertising criteria in various categories and allow an advertiser to make a selection from the predetermined advertising criteria. The advertiser matching module 208 can also set up a default list of advertising criteria in various categories to further reduce advertisers' burden.

The advertiser matching module 208 can examine the received or modified social media data with respect to the received advertising criteria using any of the known data mining and matching techniques. The data mining techniques for extracting the information from social media data that may be relevant to the advertising criteria would apply to all types of data that are likely to be in the social media data, including text, images, and videos. The data matching techniques for identifying social media data depicting users or their activities that may satisfy the advertising criteria can produce exact matches or fuzzy matches. In addition, the advertiser matching module 208 can associate different advertising criteria with different weights in the matching process, where the weights may have been supplied with the advertising criteria or determined by the advertiser matching module 208. For example, for an emerging clothing company which has a physical location in Boston and a solid online presence and whose products appeal to those at their first jobs out of college, the advertising criteria can include 1) ages between 20 and 30, 2) number of online followers above a certain threshold, 3) yearly income between thirty and sixty thousand dollars, and 4) near or at Boston. The third advertising criterion may be associated with a smaller weight than the other two advertising criteria. All of the advertising criteria can be matched with the social media contents, and at least one of them can also be matched with the social media metadata.

In some embodiments, the advertising platform interface 204 manages interactions with an advertising platform of an advertiser conducting an advertising campaign. Specifically, the advertising platform interface 204 obtains a list of one or more advertising criteria from the advertising platform by email, FTP, HTTP, or any transport protocol. The advertising criteria can be transmitted at specific times or periodically. The advertising platform interface 204 can also first make predetermined advertising criteria available to the advertising platform and then receive selections of the predetermined advertising criteria from the advertising platform.

In some embodiments, after analyzing the social media contents and metadata with respect to the advertising criteria, the advertising platform interface 204 releases IDs of social media users to the advertising platform by email, FTP, HTTP, or any transport protocol. The advertising platform interface 204 can filter the list of social media user IDs based on any filtering criteria provided by the advertiser. The advertising platform interface 204 can also make additional data available to the advertising platform, such as those portions of the social media data associated with the identified social media users that are relevant to the advertising criteria. The IDs or any additional data made available to the advertising platform can be released all at once or in batches, at specific times or periodically. The advertiser can then utilize the data received from the advertising platform interface 204 to effectively conduct its advertising campaign, by transmitting appropriate advertisements to appropriate social media users under appropriate circumstances. For example, the emerging clothing company mentioned above can send, during a lunch break or at the end of a typical workday, images of models between the ages of 20 and 30 who pose in certain Boston locations wearing the company's products, information regarding the business and specifically the company's Boston store, or coupons and promotion information to the identified social media users.

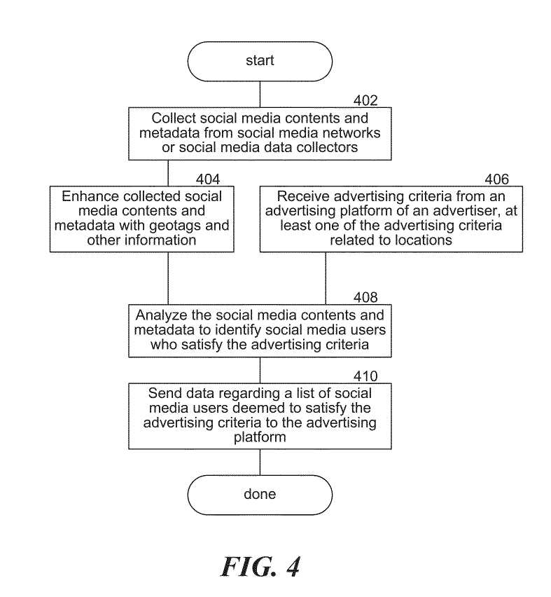

FIG. 4 illustrates an example process performed by the information management system to assist an advertising platform of an advertiser with targeting users in social media. At step 402, the system collects social media contents and metadata from social media networks, such as Facebook, or from social media data collectors, such as Firehose. The collection of the social media data can take place periodically, and each collection can be limited to a specific geographic region or timeframe or can include everything that has been produced since the last collection. At step 404, the system enhances the collected social media data with location information and other types of information. For example, the system can obtain location information from user devices connected to the same router and can also use device-specific information to aggregate social media data by user.

Independently, at step 406, the information management system gathers advertising criteria from an advertising platform of an advertiser. The advertising criteria can be created by the advertiser or determined from a pool of advertising criteria predefined by the system. The advertising criteria often include location information, since personal presence and interaction with products at a business location is often an important part of a shopping experience, and the locale itself often reflects various user conditions, such as the current weather or the user's affluence and age. The advertising criteria can otherwise be related to different attributes of a social media user. The system can also broaden, narrow, or convert the received advertising criteria to facilitate the matching process, to control the quality or size of the matching outcome, etc. The gathering of the advertising criteria can take place periodically or as requested.

At step 408, the information management system analyzes the enriched social media data with respect to the adjusted advertising criteria, using any of the known data mining and matching techniques. From the enriched social media data depicting social media users or their activities that may satisfy the adjusted advertising criteria, the system identifies those social media users. At step 410, the system makes available to the advertising platform a list of IDs of the social media users. The system can make additional data available, such as the relevant social media contents and metadata associated with these users and other information used during the data mining and matching processes. The transmission of the IDs and any additional data can take place at predetermined times using any of the possible transport protocols.

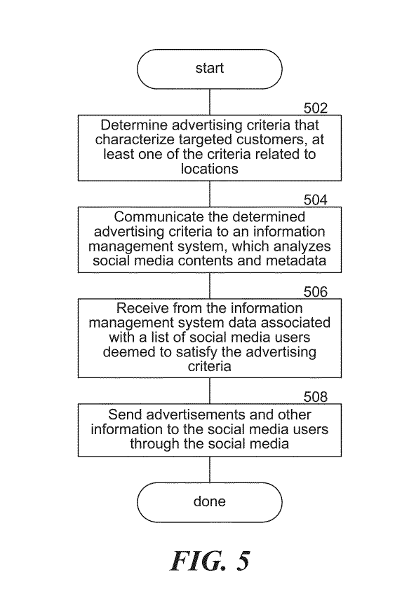

FIG. 5 illustrates an example process performed by an advertising platform to target users of social media with the assistance of the information management system. At step 502, the advertising platform determines advertising criteria that characterize targeted customers. As the targeted customers would be identified from social media users, some of the advertising criteria can be tied to the nature of social media. For example, an advertising criterion can involve users who tend to shop with others or discuss their shopping experiences with others, and another advertising criterion can involve users who are relatives or friends of one another. Such advertising criteria are likely to catch additional users as prospective customers. At step 504, the advertising platform communicates the advertising criteria to the information management system through any known type of network, such as the Internet or a cellular network. The advertising platform can initiate the communication at various times during an advertising campaign, at set intervals, and so on. In response to receiving the advertising campaign, the information management system would identify social media users who satisfy the advertising criteria by analyzing social media contents and metadata.

At step 506, the advertising platform obtains, similarly through any type of known network, a list of IDs of social media users deemed to satisfy the advertising criteria from the information management system. The information management system may deliver the list of IDs to the advertising platform, or it may make the list of IDs available locally and enable the advertising platform to retrieve the list according to various schedules. The information management system can also make available additional data associated with the social media users, such as basic demographic information of the social media users extracted from the social media data or select social media contents produced by the social media users.

At step 508, upon receiving the list of IDs of identified social media users, the advertising platform can advertise to those social media users through the social media. The advertising platform can prepare advertisements based on the advertising criteria, taking into consideration, if necessary, any additional data made available by the information management system regarding the social media users. The advertising platform can deliver to the social media users advertisements, information about the advertiser's business, information regarding discounts, promotions, and other deals, etc., at appropriate times. In addition, the advertising criteria or even strategies for product development and marketing can be updated based on the data received from the information management system. For example, while an advertising criterion may specify an age range between 15 and 25, the received data may reveal that social media users who also satisfy the other advertising criteria tend to be older than 22. As a result, the advertising may want to broaden its age criterion or adjust the product focus to target an older user group. Such targeted advertising towards people who are intended customers and who might be especially interested in the advertiser's products and services can be particularly effective.

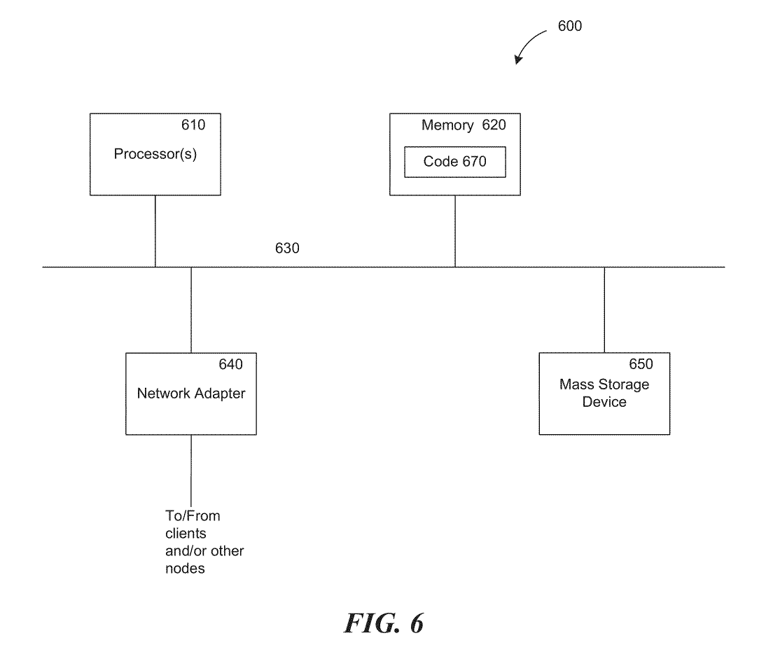

FIG. 6 contains a high-level block diagram showing an example architecture of a computer, which may represent any electronic device, such as a mobile device or a server, including any node within a cloud service as described herein, such as may implement the operations described above. The computer 600 includes one or more processors 610 and memory 620 coupled to an interconnect 630. The interconnect 630 shown in FIG. 6 is an abstraction that represents any one or more separate physical buses, point-to-point connections, or both, connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus, also called “Firewire”.

The processor(s) 610 is/are the central processing unit (CPU) of the computer 600 and, thus, control the overall operation of the computer 600. In certain embodiments, the processor(s) 610 accomplish this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 620 is or includes the main memory of the computer 600. The memory 620 represents any form of random access memory (RAM), read-only memory (ROM), flash memory, or the like, or a combination of such devices. In use, the memory 620 may contain code 670 containing instructions according to the techniques disclosed herein.

Also connected to the processor(s) 610 through the interconnect 630 are a network adapter 640 and a mass storage device 650. The network adapter 640 provides the computer 600 with the ability to communicate with remote devices over a network and may be, for example, an Ethernet adapter. The network adapter 640 may also provide the computer 600 with the ability to communicate with other computers.

The code 670 stored in memory 620 may be implemented as software and/or firmware to program the processor(s) 610 to carry out actions described above. In certain embodiments, such software or firmware may be initially provided to the computer 600 by downloading it from a remote system through the computer 600 (e.g., via network adapter 640).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware used for implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer-readable medium that can direct a computer, other programmable data processing apparatus, or other devices to function in a particular manner, such that the instructions stored in the computer-readable medium produce an article of manufacture, including instructions which implement the function/act specified in the flowchart and/or block diagram block or blocks.

The computer program instructions may also be loaded onto a computer, other programmable data processing apparatuses, or other devices to cause a series of operational steps to be performed on the computer, other programmable apparatuses or other devices to produce a computer-implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts or by combinations of special-purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some, but not necessarily all, embodiments of the inventions.

It is to be understood that the phraseology and terminology employed herein are not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

1. A system for targeted advertising using location-based social media feeds, comprising:
a processor and memory, cooperating to function as:
a first receiving unit configured to receive router data from one or more network routers;
a second receiving unit configured to receive from a data provider social media data created by one or more media users;
an enhancing unit configured to enhance the social media data with location information based on the router data;
a third receiving unit configured to receive from an advertising platform one or more advertising criteria for identifying advertising targets,
wherein one of the advertising criteria is related to a physical location;
an analyzing unit configured to analyze the enhanced social media data with respect to the advertising criteria;
a determining unit configured to determine a subset of the media users who satisfy the advertising criteria based on the analysis; and
a releasing unit configured to release IDs of the subset of media users to the advertising platform.

2. The system of claim 1,
wherein the router data includes first data from one of the network routers regarding a first visit by a first device of a first website associated with a first content provider,
wherein the first device is connected to the one network router and associated with a first user,
wherein the router data includes second data from the one network router regarding a second visit by a second device of a second website associated with a second content provider,
wherein the second device is connected to the one network router and associated with a second user,
wherein the social media data includes first details originally published in a first publication by the first content provider and is not tagged with a physical location, and
wherein the social media includes second details originally published in a second publication by the second content provider and is tagged with a first physical location.

3. The system of claim 2, wherein the enhancing unit tags the first details with the first physical location upon determining that:
a first time associated with the first publication matches a second time associated with the first visit, or the first time falls in a first time range in which the first device is connected to the one network router when the first details are created by the first user, and
a third time associated with the second publication matches a fourth time associated with the second visit, or the third time falls in a second time range in which the second device is connected to the one network router when the second details are created by the second user.

4. The system of claim 2,
wherein the router data includes information on a second physical location of the one network router, and
wherein the enhancing unit tags the first details with the second physical location upon learning that a first time associated with the first publication matches a second time associated with the first visit, or the first time falls in a time range in which the first device is connected to the one network router when the first details are created by the first user.

5. The system of claim 1, wherein the releasing unit releases the enhanced social media data associated with the subset of media users together with the IDs.

6. The system of claim 1,
wherein the first receiving unit further receives a schedule from the advertising platform, and
wherein the releasing unit releases the IDs of the subset of media users according the schedule.

7. The system of claim 1, wherein the analyzing unit identifies text, an image, or a video in the enhanced social media data that is related to one of the advertising criteria.

8. The system of claim 1, wherein one of the advertising criteria is related to demographic information, a time of action, a hobby, an industry of interest, an extent of social influence, a shopping style, or a purchase preference of a media user.

9. The system of claim 1, wherein the physical location is expressed as a geo-fence.

10. The system of claim 1, wherein the network routers include a wireless network router.

11. A system for targeted advertising in social media, comprising:
a processor and memory, cooperating to function as:
a first receiving unit configured to receive from an advertising platform one or more advertising criteria for identifying advertising targets,
wherein one of the advertising criteria is related to a physical location;
a second receiving unit configured to receive from a data provider a plurality of social media contents created by one or more users and associated metadata;
an analyzing unit configured to analyze the received social media contents and metadata with respect to the received advertising criteria;
a determining unit configured to determine a subset of the users who satisfy the advertising criteria based on the analysis; and
a releasing unit configured to release information regarding the subset of users to the advertising platform.

12. A computer-implemented method of targeted advertising in social media, comprising:
sending, by a processor, one or more advertising criteria for identifying advertising targets to a social media monitoring system,
wherein one of the advertising criteria is related to a physical location, and
wherein the social media monitoring system analyzes contents and metadata of one or more social media with respect to the advertising criteria; and
receiving, by the processor, from the social media monitoring system IDs of social media users who satisfy the advertising criteria based on the analysis.

13. The computer-implemented method of claim 12, further comprising:
selecting an advertisement based on one of the advertising criteria; and
delivering the advertisement to one of the social media users through a social medium used by the one social media user.

14. The computer-implemented method of claim 12, further comprising receiving the social media contents associated with the social media users and the associated metadata.

15. The computer-implemented method of claim 14, further comprising:
creating an advertisement for one of the social media users based on the social media contents associated with the one user or the associated metadata; and
delivering the advertisement to the one social media user through a social medium used by the one social media user.

16. The computer-implemented method of claim 14, further comprising updating one of the advertising criteria based on the received social media contents and metadata.

17. A computer-readable storage medium whose contents are capable of causing a computing system to perform a method of targeted advertising using location-based social media feeds, the method comprising:
receiving router data from one or more network routers;
receiving social media data created by one or more users from a data provider;
enhancing the social media data with location information based on the router data;
receiving from an advertising platform one or more target criteria for identifying advertising targets,
wherein one of the target criteria is related to a physical location;
analyzing the enhanced social media with respect to the advertising criteria;
determining a subset of the users who satisfy the advertising criteria based on the analysis; and
delivering information regarding the subset of users to the advertising platform.

18. The computer-readable storage medium of claim 17, the method further comprising communicating to the advertising system the social media contents created by the subset of users and the associated metadata.

19. The computer-readable storage medium of claim 17, wherein the analyzing includes identifying text, an image, or a video in the social media data that is related to one of the advertising criteria.

20. The computer-readable storage medium of claim 17, wherein the physical location is expressed as a geo-fence, a longitude and an latitude, or a mailing address.
